(19) United States
(12) Patent Application Publication
(10) Pub. No.: US 2006/0202166 A1
(43) Pub. Date: Sep. 14, 2006

(54) Carbazolyl-functional linear polysiloxanes, silicone composition, and organic light-emitting diode

(75) Inventors: Toshio Suzuki, Midland, MI (US); Shihe Xu, Midland, MI (US)

Correspondence Address: DOW CORNING CORPORATION CO1232, 2200 W. SALZBURG ROAD, P.O. BOX 994, MIDLAND, MI, 48686-0994, US

(73) Assignee: DOW CORNING CORPORATION, Midland, MI (US)

(21) Appl. No.: 10/565,133

(22) PCT Filed: Jun. 28, 2004
(86) PCT No.: PCT/US04/20720

§ 371 Date: Jan. 18, 2006

Related U.S. Application Data
(60) Provisional application No. 60/496,466, filed on Aug. 20, 2003.

(51) Int. Cl. C09K 11/06

(52) U.S. Cl. 252/301.16; 313/506

(57) ABSTRACT

Carbazolyl-functional linear polysiloxanes containing N-carbazolylalkyl groups and hydrolysable groups, a silicone composition containing a carbazolyl-functional linear polysiloxane, a curd carbazolyl-functional polysiloxane prepared by curing the silicone composition, and an organic light-emitting diode (OLED) containing a carbazolyl-functional polysiloxane.

The present invention relates to carbazolyl-functional linear polysiloxanes and more particularly to carbazolyl-functional linear polysiloxanes containing N-carbazolylalkyl groups and hydrolysable groups. The present invention also relates to a silicone composition containing a carbazolyl-functional linear polysiloxane, a cured carbazolyl-functional polysiloxane prepared by curing the silicone composition, and an organic light-emitting diode (OLED) containing a carbazolyl-functional polysiloxane.

### BACKGROUND OF THE INVENTION

Carbazolyl-functional linear polysiloxanes containing carbazolylalkyl groups are known in the art. For example, Strohriegl (Makromol. Chem., Rapid Commun., 1986, 7, 771-775) describes the preparation and characterization of a series of polysiloxanes with pendant carbazole groups, wherein the carbazole units are separated from the siloxane backbone by alkylene spacers.

U.S. Pat. No. 4,933,053 to Tieke discloses electrically conductive polymers obtainable by anodic oxidation of starting polymers consisting of 5-100 mol % of recurring structural units of the formula I and 95-0 mol % of recurring structural units of the formula II 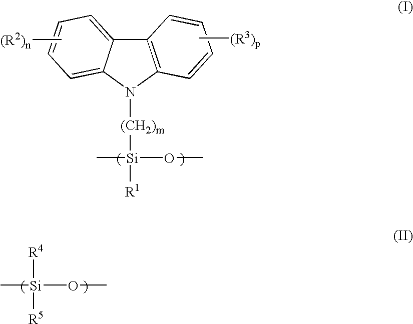
in which R¹ and R⁴ independently of one another are C₁-C₄ alkyl, C₁-C₄ alkoxy, phenyl or phenoxy, R² and R³ independently of one another are C₁-C₄ alkyl, C₁-C₄ alkoxy, halogen, cyano or nitro, R⁵ is C₁-C₁₈ alkyl, which is unsubstituted or can be substituted by one or two hydroxyl groups, or is phenyl or hydroxyl, m is an integer from 3-11, and n and p independently of one another are integers from 0 to 2. The '053 patent teaches the products are suitable especially as electrochromic display elements, as a positive electrode material or as electrically conductive films.

Derwent Abstract No. 1987-158535 of European Patent Application No. EP 0224784 to Leyrer et al. discloses polysiloxanes having lateral carbazole groups attached to the main polymer chain. The Abstract teaches the polysiloxanes can be used in electrophotographic recording materials and for providing electrophotographic offset printing plates.

The Patent Abstracts of Japan publication corresponding to Japanese Patent Application No. 02127432 to Kazumasa et al. discloses a carbazole group-containing curable composition containing (A) a carbazole group-containing curable compound having a carbazole group, OH group bonded to silicon atom or hydrolysable group and silicon atom-containing group crosslinkable by forming a siloxane bond and (B) a silanol condensation catalyst.

Although, the aforementioned references disclose linear polysiloxanes containing carbazolylalkyl groups, they do not disclose the carbazolyl-functional linear polysiloxanes, silicone composition, cured carbazolyl-functional polysiloxane, or OLED of the present invention.

### SUMMARY OF THE INVENTION

The present invention is directed to a carbazolyl-functional linear polysiloxane comprising from 30 to 99 mol % of units having the formula I, from 1 to 70 mol % of units having the formula II, and units having the formula III: 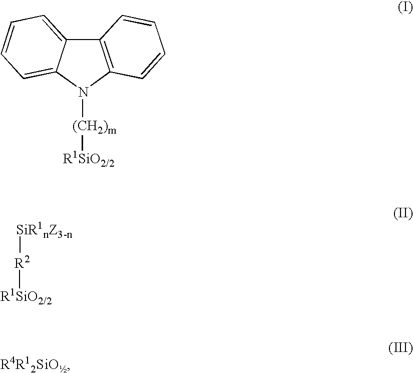
wherein R¹ is C₁ to C₁₀ hydrocarbyl free of aliphatic unsaturation; R² is —CH₂—CHR³— or —CH₂—CHR³—Y—, wherein Y is a divalent organic group and R³ is R¹ or —H; R⁴ is R¹, —(CH₂)ₘ-Cz, —CH₂—CHR³—SiR¹ₙZ₃₋ₙ, or —CH₂—CHR³—Y—SiR¹ₙZ₃₋ₙ, wherein Cz is N-carbazolyl; Z is a hydrolysable group; m is an integer from 2 to 10; and n is 0, 1, or 2.

The present invention is also directed to a carbazolyl-functional linear polysiloxane comprising at least 30 mol % of units having the formula I and units having the formula IV: 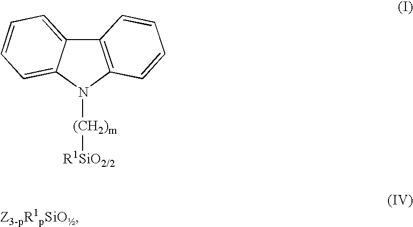
wherein R¹ is C₁ to C₁₀ hydrocarbyl free of aliphatic unsaturation; Z is a hydrolysable group; m is an integer from 2 to 10; and p is 0, 1, or 2.

The present invention is also directed to a silicone composition comprising a polysiloxane selected from the aforementioned carbazolyl-functional linear polysiloxanes, and an organic solvent. The present invention is further directed to a cured carbazolyl-functional polysiloxane prepared by curing the silicone composition.

The instant invention is still further directed to an organic light-emitting diode comprising:

a substrate having a first opposing surface and a second opposing surface;

a first electrode layer overlying the first opposing surface;

a light-emitting element overlying the first electrode layer, the light emitting element comprising
a hole-transport layer and
an electron-transport layer, wherein the hole-transport layer and the electron-transport layer lie directly on one another, and one of the hole-transport layer and the electron-transport layer comprises a carbazolyl-functional polysiloxane selected from
   a cured carbazolyl-functional polysiloxane prepared by curing a silicone composition comprising (A) a polysiloxane selected from (i) at least one carbazolyl-functional linear polysiloxane comprising from 30 to 99 mol % of units having the formula I, from 1 to 70 mol % of units having the formula II, and units having the formula III: 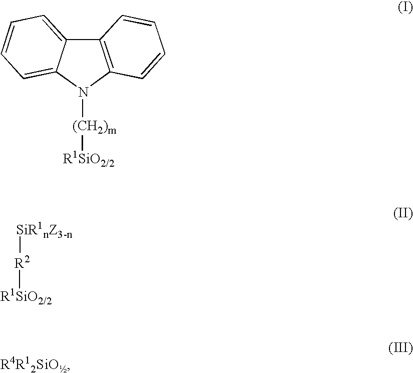
wherein R¹ is C₁ to C₁₀ hydrocarbyl free of aliphatic unsaturation, R² is —CH₂—CHR³— or —CH₂—CHR³—Y—, wherein Y is a divalent organic group and R³ is R¹ or —H, R⁴ is R¹, —(CH₂)ₘ-Cz, —CH₂—CHR³—SiR¹ₙZ₃₋ₙ, or —CH₂—CHR³—Y—SiR¹ₙZ₃₋ₙ, wherein Cz is N-carbazolyl, Z is a hydrolysable group, m is an integer from 2 to 10, nd n is 0, 1, or 2, (ii) at least one carbazolyl-functional linear polysiloxane comprising at least 30 mol % of units having the formula I and units having the formula IV: 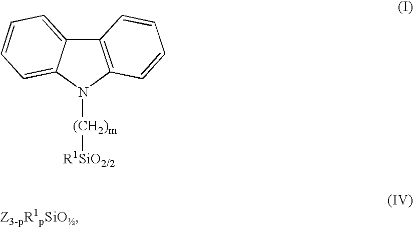
wherein R¹ is C₁ to C₁₀ hydrocarbyl free of aliphatic unsaturation, Z is a hydrolysable group, m is an integer from 2 to 10, and p is 0, 1, or 2, and (iii) a mixture comprising (i) and (ii), and (B) an organic solvent, and
   at least one carbazolyl-functional linear polysiloxane comprising at least 50 mol % of units having the formula I, and units having the formula V: 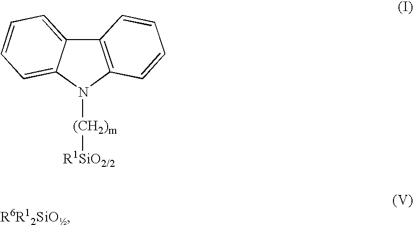
wherein R¹ is C₁ to C₁₀ hydrocarbyl free of aliphatic unsaturation, m is from 2 to 10, and R⁶ is R¹ or —(CH₂)ₘ-Cz, wherein Cz is N-carbazolyl; and

a second electrode layer overlying the light-emitting element.

The carbazolyl-functional linear polysiloxanes of the present invention exhibit electroluminescence, emitting light when subjected to an applied voltage. Moreover, the linear polysiloxanes contain hydrolysable groups and can be cured to produce durable cross-linked polysiloxanes. Also, the linear polysiloxanes can be doped with small amounts of fluorescent dyes to enhance the electroluminescent efficiency and control the color output of the cured polysiloxane.

The silicone composition of the present invention can be conveniently formulated as a one-part composition. Moreover, the silicone composition has good shelf-stability in the absence of moisture. Importantly, the composition can be applied to a substrate by conventional high-speed methods such as spin coating, printing, and spraying. Also, the silicone composition can be readily cured by exposure to moisture at mild to moderate temperatures.

The cured carbazolyl-functional polysiloxane prepared by curing the silicone composition of the present invention exhibits electroluminescence. Moreover, the cured polysiloxane has good primeness adhesion to a variety of substrates. The cured polysiloxane also exhibits excellent durability, chemical resistance, and flexibility at low temperatures. Additionally, the cured polysiloxane exhibits high transparency, typically at least 95% transmittance at a thickness of 100 nm, in the visible region of the electromagnetic spectrum. Importantly, the polysiloxane is substantially free of acidic or basic components, which are detrimental to the electrode and light-emitting layers in OLED devices.

The OLED of the present invention exhibits good resistance to abrasion, organic solvents, moisture, and oxygen. Moreover, the OLED exhibits high quantum efficiency and photostability.

The OLED is useful as a discrete light-emitting device or as the active element of light-emitting arrays or displays, such as flat panel displays. OLED displays are useful in a number of devices, including watches, telephones, lap-top computers, pagers, cellular phones, digital video cameras, DVD players, and calculators.

These and other features, aspects, and advantages of the present invention will become better understood with reference to the following description, appended claims, and accompanying drawing.

### BRIEF DESCRIPTION OF THE DRAWINGS

FIG. 1 shows a cross-sectional view of a first embodiment of an OLED according to the present invention.

FIG. 2 shows a cross-sectional view of a second embodiment of an OLED according to the present invention.

FIG. 3 shows a cross-sectional view of a third embodiment of an OLED according to the present invention.

FIG. 4 shows a cross-sectional view of a fourth embodiment of an OLED according to the present invention.

### DETAILED DESCRIPTION OF THE INVENTION

As used herein, the term “linear carbazolyl-functional polysiloxane” refers to a carbazolyl-functional polysiloxane comprising an average of at least 90 mol %, alternatively at least 95 mol %, alternatively at least 98 mol %, of difunctional siloxane units (i.e., D units) and monofunctional siloxane units (i.e., M units), combined, per molecule. As used herein, the “mol %” of siloxane units or combination of siloxane units is defined as the ratio of the number of moles of the siloxane units or combination of siloxane units to the total number of moles of siloxane units in the polysiloxane, multiplied by 100. Also, the term “hydrocarbyl group free of aliphatic unsaturation” means the group is free of aliphatic carbon-carbon double bonds and aliphatic carbon-carbon triple bonds.

A first carbazolyl-functional linear polysiloxane according to the present invention comprises from 30 to 99 mol % of units having the formula I, from 1 to 70 mol % of units having the formula II, and units having the formula III: 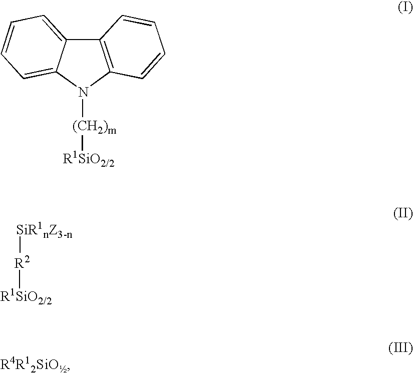
wherein R¹ is C₁ to C₁₀ hydrocarbyl free of aliphatic unsaturation; R² is —CH₂—CHR³— or —CH₂—CHR³—Y—, wherein Y is a divalent organic group and R³ is R¹ or —H; R⁴ is R¹, —(CH₂)ₘ-Cz, —CH₂—CHR³—SiR¹ₙZ₃₋ₙ, or —CH₂—CHR³—Y—SiR¹ₙZ₃₋ₙ, wherein Cz is N-carbazolyl; Z is a hydrolysable group; m is an integer from 2 to 10; and n is 0, 1, or 2. Alternatively, the subscript m has a value of from 3 to 10 or from 3 to 6.

The hydrocarbyl groups represented by R¹ and R⁴ are free of aliphatic unsaturation and typically have from 1 to 10 carbon atoms, alternatively from 1 to 6 carbon atoms. Acyclic hydrocarbyl groups containing at least 3 carbon atoms can have a branched or unbranched structure. Examples of hydrocarbyl groups include, but are not limited to, alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, decyl, undecyl, dodecyl, tridecyl, tetradecyl, pentadecyl, hexadecyl, heptadecyl, and octadecyl; cycloalkyl, such as cyclopentyl, cyclohexyl, and methylcyclohexyl; aryl, such as phenyl and naphthyl; alkaryl, such as tolyl and xylyl; and aralkyl, such as benzyl and phenethyl.

In formula (III), R⁴ can be —(CH₂)ₘ₋₂-Cz, wherein Cz is N-carbazolyl and m is an integer from 2 to 10. As used herein, the term “N-carbazolyl” refers to a group having the formula:

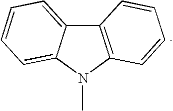

The divalent organic groups represented by Y typically have from 1 to 18 carbon atoms, alternatively from 1 to 10 carbon atoms, alternatively from 1 to 6 carbon atoms. In addition to carbon and hydrogen, the divalent organic groups may contain other atoms such as nitrogen, oxygen, and halogen, provided the divalent group does not inhibit the hydrosilylation reaction, described below, used to prepare the polysiloxane or react with the hydrolysable group Z in the polysiloxane. Examples of divalent organic groups represented by Y include, but are not limited to, hydrocarbylene such as methylene, propylene, and phenylene; halogen-substituted hydrocarbylene such as chloroethylene and fluoroethylene; and alkyleneoxyalkylene such as —CH₂OCH₂CH₂CH₂—, —CH₂CH₂OCH₂CH₂—, —CH₂CH₂OCH(CH₃)CH₂—, and —CH₂OCH₂CH₂OCH₂CH₂—; and carbonyloxyalkylene, such as C(═O)O—(CH₂)₃—.

As used herein, the term “hydrolysable group” means the silicon-bonded group Z can react with water to form a silicon-bonded —OH (silanol) group. Examples of hydrolysable groups represented by Z include, but are not limited to, —Cl, Br, —OR⁵, —OCH₂CH₂OR⁵, CH₃C(═O)O—, Et(Me)C═N—O—, CH₃C(═O)N(CH₃)—, and —ONH₂, wherein R⁵ is C₁ to C₈ hydrocarbyl or halogen-substituted hydrocarbyl, both free of aliphatic unsaturation.

Examples of hydrocarbyl groups represented by R⁵ include, but are not limited to, unbranched and branched alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, and octyl; cycloalkyl, such as cyclopentyl, cyclohexyl, and methylcyclohexyl; phenyl; alkaryl, such as tolyl and xylyl; and aralkyl, such as benzyl and phenethyl. Examples of halogen-substituted hydrocarbyl groups include, but are not limited to, 3,3,3-trifluoropropyl, 3-chloropropyl, chlorophenyl, and dichlorophenyl.

The first carbazolyl-functional linear polysiloxane is a copolymer comprising units having formulae (I), (II), and (III), above. The polysiloxane contains from 30 to 99 mol %, alternatively from 75 to 99 mol %, alternatively from 80 to 95 mol %, of units having formula (I). The polysiloxane also contains from 1 to 70 mol %, alternatively from 5 to 50 mol %, alternatively from 5 to 15 mol %, of units having formula (II). In addition to units having formulae (I), (II), and (III), above, the first carbazolyl-functional linear polysiloxane may contain up to 30 mol %, alternatively up to 15 mol %, alternatively up to 5 mol %, of other siloxane units. Examples of other siloxane units include, but are not limited to, units having the following formulae: R¹HSiO_{2/2}, HR¹₂SiO_{1/2}, and R¹₂SiO_{2/2}.

The first carbazolyl-function polysiloxane typically has a number-average molecular weight of from 1,000 to 1,000,000, alternatively from 2,500 to 150,000, alternatively from 10,000 to 30,000, where the molecular weight is determined by gel permeation chromatography employing a low angle laser light scattering detector.

Examples of the first carbazolyl-functional linear polysiloxane include, but are not limited to, polysiloxanes having the following average formulae: (Me)₃SiO[Si(Me)(CH₂CH₂CH₂Cz)O]_{0.93}[Si(Me)(CH₂CH₂CH₂Si(OMe)₃)O]_{0.05}Si(Me)₃, (Me)₃SiO[Si(Me)(CH₂CH₂CH₂Cz)O]_{0.86}[Si(Me)(CH₂CH₂CH₂Si(OMe)₃)O]_{0.1}Si(Me)₃, (Me)₃SiO[Si(Me)(CH₂CH₂CH₂Cz)O]_{0.8}[Si(Me)(CH₂CH₂CH₂Si(OMe)₃)O]_{0.1}[SiO(Me)(H)]_{0.05}Si(Me)₃, (Me)₃SiO[Si(Et)(CH₂CH₂CH₂Cz)O]_{0.93}[Si(Et)(CH₂CH₂CH₂Si(OMe)₃)O]_{0.05}Si(Me)₃, (Me)₃SiO[Si(Et)(CH₂CH₂CH₂Cz)O]_{0.86}[Si(Et)(CH₂CH₂CH₂Si(OMe)₃)O]_{0.1}Si(Me)₃, (Me)₃SiO[Si(Et)(CH₂CH₂CH₂Cz)O]_{0.8}[Si(Et)(CH₂CH₂CH₂Si(OMe)₃)O]_{0.1}[SiO(Et)(H)]_{0.05}Si(Me)₃, (Me)₃SiO[Si(Ph)(CH₂CH₂CH₂Cz)O]_{0.93}[Si(Ph)(CH₂CH₂CH₂Si(OMe)₃)O]_{0.05}Si(Me)₃, (Me)₃SiO[Si(Ph)(CH₂CH₂CH₂Cz)O]_{0.86}[Si(Ph)(CH₂CH₂CH₂Si(OMe)₃)O]_{0.1}Si(Me)₃, (Me)₃SiO[Si(Ph)(CH₂CH₂CH₂Cz)O]_{0.8}[Si(Ph)(CH₂CH₂CH₂Si(OMe)₃)]O_{0.1}[SiO(Ph)(H)]_{0.05}Si(Me)₃, (Me)₃SiO[Si(Me)(CH₂CH₂CH₂Cz)O]_{0.93}[Si(Me)(CH₂CH(Me)CO₂CH₂CH₂CH₂Si(OMe)₃)O]_{0.05}Si(Me)₃, (Me)₃SiO[Si(Me)(CH₂CH₂CH₂Cz)O]_{0.86}[Si(Me)(CH₂CH(Me)CO₂CH₂CH₂CH₂Si(OMe)₃)O]_{0.1}Si(Me)₃, and (Me)₃SiO[Si(Me)(CH₂CH₂CH₂Cz)O]_{0.8}[Si(Me)(CH₂CH(Me)CO₂CH₂CH₂CH₂Si(OMe)₃)O]_{0.1}[SiO(Me)(H)]_{0.05}Si(Me)₃, wherein Me is methyl, Et is ethyl, Ph is phenyl, and the numerical subscripts denote mole fractions. Also, in the preceding formulae, the sequence of the units is unspecified.

The first carbazolyl-functional linear polysiloxane can be prepared by reacting (a) an organohydrogenpolysiloxane having the formula R³R¹₂SiO(R¹HSiO)ₐSiR¹₂R³ with (b) an N-alkenyl carbazole having the formula Cz-(CH₂)ₘ₋₂—CH═CH₂ and (c) an alkenyl silane having a formula selected from Z₃₋ₙR¹ₙSi—Y—CR³═CH₂ and Z₃₋ₙR¹ₙSi—CR³═CH₂ in the presence of (d) a hydrosilylation catalyst and, optionally, (e) an organic solvent, wherein subscript a has a value such that the organohydrogenpolysiloxane has a number-average molecular weight of from 180 to 220,000; and R¹, R³, Cz, Y, Z, m, and n are as defined and exemplified above for the first carbazolyl-functional linear polysiloxane.

Organohydrogenpolysiloxane (a) has the formula R³R¹₂SiO(R¹HSiO)ₐSiR¹₂R³, wherein R¹ and R³ are as defined and exemplified above for the first carbazolyl-functional linear polysiloxane, and the subscript a has a value such that the organohydrogenpolysiloxane typically has a number-average molecular weight of from 180 to 220,000, alternatively from 1,000 to 150,000, alternatively from 1,000 to 75,000.

Examples of organohydrogenpolysiloxanes suitable for use as organohydrogenpolysiloxane (a) include, but are not limited to, trimethylsiloxy-terminated poly(methylhydrogensiloxane)s, hydrogendimethylsiloxy-terminated poly(methylhydrogensiloxane)s, triethylsiloxy-terminated poly(methylhydrogensiloxane)s, hydrogendiethylsiloxy-terminated poly(methylhydrogensiloxane)s, trimethylsiloxy-terminated poly(ethylhydrogensiloxane)s, hydrogendimethylsiloxy-terminated poly(ethylhydrogensiloxane)s, triethylsiloxy-terminated poly(ethylhydrogensiloxane)s, hydrogendiethylsiloxy-terminated poly(ethylhydrogensiloxane)s, trimethylsiloxy-terminated poly(phenylhydrogensiloxane)s, hydrogendimethylsiloxy-terminated poly(phenylhydrogensiloxane)s, triethylsiloxy-terminated poly(phenylhydrogensiloxane)s, and hydrogendiethylsiloxy-terminated poly(phenylhydrogensiloxane)s.

Methods of preparing organohydrogenpolysiloxanes, exemplified by the production of poly(methylhydrogen)siloxanes, are well known in the art. For example, poly(methylhydrogen)siloxanes having a degree of polymerization up to about 500 can be prepared by hydrolysis and condensation of the appropriate organohalosilanes, according to U.S. Pat. No. 2,491,843. Poly(methylhydrogen)siloxanes having a number-average molecular weight greater than 10⁵ can be prepared by polymerization of 1,3,5,7-tetramethylcyclotetrasiloxane using trifluoromethanesulfonic acid as the initiator in methylene chloride at ambient temperature, as described by Gupta et al. (Polym. J., 1993, 29 (1), 15-22). Alternatively relatively high molecular weight (Mₙ=7,000-70,000) poly(methylhydrogen)siloxanes can be prepared by polymerization of 1,3,5,7-tetramethylcyclotetrasiloxane in an aqueous emulsion using dodecylbenzenesulfonic acid and Brij 35 [polyoxyethylene(23) lauryl ether] as the emulsifier/initiator and coemulsifier, respectively, as taught by Maisonnier et al. (Polym. Int., 1999, 48, 159-164). Further, linear triorganosiloxy-endcapped poly(methylhydrogen)siloxanes having a degree of polymerization up to about 2200 can be prepared by (i) forming a reaction mixture containing a silanol-free hexaorganodisiloxane, one or more silanol-free methylhydrogen cyclic siloxanes, and less than about 100 parts per million water, (ii) contacting the reaction mixture with anhydrous trifluoromethanesulfonic acid catalyst, and (iii) agitating the mixture and the catalyst at below 100° C. to form a linear triorganosiloxy-endcapped methylhydrogen polysiloxane, as disclosed in U.S. Pat. No. 5,554,708.

N-alkenyl carbazole (b) is at least one N-alkenyl carbazole having the formula Cz-(CH₂)ₘ₋₂—CH═CH₂, wherein Cz and m are as defined and exemplified above for the first carbazolyl-functional linear polysiloxane.

Examples of N-alkenyl carbazoles suitable for use as N-alkenyl carbazole (b) include, but are not limited to, carbazoles having the following formulae: CH₂═CH-Cz, CH₂═CH—CH₂-Cz, CH₂═CH—(CH₂)₃-Cz, CH₂═CH—(CH₂)₅-Cz, and CH₂═CH—(CH₂)₈-Cz, wherein Cz is N-carbazolyl.

N-alkenyl carbazole (b) can be a single N-alkenyl carbazole or a mixture comprising two or more different N-alkenyl carbazoles, each having the formula Cz-(CH₂)ₘ₋₂—CH═CH₂, wherein Cz and m are as defined and exemplified above for the first carbazolyl-functional linear polysiloxane.

Methods of preparing N-alkenyl carbazoles are well known in the art. For example, the N-alkenyl carbazoles can be prepared by reacting an co-alkenyl bromide having the formula Br—(CH₂)ₘ₋₂—CH═CH₂ with sodium carbazole, as described by Heller et al. (Makromol. Chem., 1964, 73, 48).

Alkenyl silane (c) is at least one alkenyl silane having a formula selected from Z₃₋ₙR¹ₙSi—Y—CR³═CH₂ and Z₃₋ₙR¹ₙSi—CR³═CH₂, wherein R¹, R³, Y, Z, and n are as defined and exemplified above for the first carbazolyl-functional linear polysiloxane.

Examples of alkenyl silanes suitable for use as alkenyl silane (c) include, but are not limited to, silanes having the following formulae: CH₂═C(Me)—C(═O)—OCH₂CH₂CH₂Si(OMe)₃, CH₂═CH—Si(OAc)₃, CH₂═CH—(CH₂)₉—Si(OMe)₃, CH₂═CH—Si(OAc)₂(OMe), and CH₂═CH—CH₂—Si(OMe)₃, where Me is methyl and OAc is acetoxy.

Alkenyl silane (c) can be a single alkenyl silane or a mixture comprising two or more different alkenyl silanes, each having a formula selected from Z₃₋ₙR¹ₙSi—Y—CR³═CH₂ and Z₃₋ₙR¹ₙSi—CR³═CH₂, wherein R¹, R³, Y, Z, and n are as defined and exemplified above for the first carbazolyl-functional linear polysiloxane.

Methods of preparing alkenyl silanes are well known methods in the art. For example, alkenyl silanes can be prepared by direct syntheses, Grignard reactions, addition of organosilicon hydrides to alkenes or alkynes, condensation of chloroolefins with organosilicon hydrides, and dehydrohalogenation of haloalkylsilanes. These and other methods are described by W. Noll in Chemistry and Technology of Silicones, Academic Press: New York, 1968.

Hydrosilylation catalyst (d) can be any of the well-known hydrosilylation catalysts comprising a platinum group metal (i.e., platinum, rhodium, ruthenium, palladium, osmium and iridium) or a compound containing a platinum group metal. Preferably, the platinum group metal is platinum, based on its high activity in hydrosilylation reactions.

Preferred hydrosilylation catalysts include the complexes of chloroplatinic acid and certain vinyl-containing organosiloxanes disclosed by Willing in U.S. Pat. No. 3,419,593, which is hereby incorporated by reference. A preferred catalyst of this type is the reaction product of chloroplatinic acid and 1,3-diethenyl-1,1,3,3-tetramethyldisiloxane.

Organic solvent (e) is at least one organic solvent. The organic solvent can be any aprotic or dipolar aprotic organic solvent that does not react with organohydrogen-polysiloxane (a), N-alkenyl carbazole (b), alkenyl silane (c), or the first carbazolyl-functional linear polysiloxane under the conditions of the present method, and is miscible with components (a), (b), (c), and the carbazolyl-functional linear polysiloxane.

Examples of organic solvents include, but are not limited to, saturated aliphatic hydrocarbons such as n-pentane, hexane, n-heptane, isooctane and dodecane; cycloaliphatic hydrocarbons such as cyclopentane and cyclohexane; aromatic hydrocarbons such as benzene, toluene, xylene and mesitylene; cyclic ethers such as tetrahydrofuran (THF) and dioxane; ketones such as methyl isobutyl ketone (MIBK); halogenated alkanes such as trichloroethane; and halogenated aromatic hydrocarbons such as bromobenzene and chlorobenzene. Organic solvent (e) can be a single organic solvent or a mixture comprising two or more different organic solvents, each as defined above.

The reaction can be carried out in any standard reactor suitable for hydrosilylation reactions. Suitable reactors include glass and Teflon-lined glass reactors. Preferably, the reactor is equipped with a means of agitation, such as stirring. Also, preferably, the reaction is carried out in an inert atmosphere, such as nitrogen or argon, in the absence of moisture.

The organohydrogenpolysiloxane, N-alkenyl carbazole, alkenyl silane, hydrosilylation catalyst, and organic solvent can be combined in any order. Typically, N-alkenyl carbazole (b) and alkenyl silane (c) are added, either simultaneously or sequentially in any order, to organohydrogenpolysiloxane (a), and, optionally organic solvent (e) before the introduction of hydrosilylation catalyst (d). When organic solvent (e) is present, hydrosilylation catalyst (d) is added to the mixture of (a), (b), (c), and (e). When organic solvent (e) is not present, the mixture of (a), (b), and (c) is heated to a temperature sufficient to form a melt, for example 60° C., and hydrosilylation catalyst (d) is added to the melt.

The reaction is typically carried out at a temperature of from 0 to 140° C., alternatively from room temperature (˜23° C.) to 140° C. When the temperature is less than 0° C., the rate of reaction is typically very slow.

The reaction time depends on several factors, such as the structures of the organohydrogenpolysiloxane, N-alkenyl carbazole, and alkenyl silane, and the temperature. The time of reaction is typically from 2 to 48 h at a temperature of from room temperature to 140° C. The optimum reaction time can be determined by routine experimentation using the methods set forth in the Examples section below.

The mole ratio of N-alkenyl carbazole (b) to silicon-bonded hydrogen atoms in organohydrogenpolysiloxane (a) is typically from 0.8 to 1.2, alternatively from 0.8 to 0.95. The mole ratio of alkenyl silane (c) to silicon-bonded hydrogen atoms in organohydrogenpolysiloxane (a) is typically from 0.05 to 0.25, alternatively from 0.05 to 0.1.

The concentration of hydrosilylation catalyst (d) is sufficient to catalyze the addition reaction of organohydrogenpolysiloxane (a) with N-alkenyl carbazole (b) and alkenyl silane (c). Typically, the concentration of hydrosilylation catalyst (d) is sufficient to provide from 0.1 to 1000 ppm of a platinum group metal, alternatively from 1 to 500 ppm of a platinum group metal, alternatively from 5 to 150 ppm of a platinum group metal, based on the combined weight of organohydrogenpolysiloxane (a), N-alkenyl carbazole (b), and alkenyl silane (c). The rate of reaction is very slow below 0.1 ppm of platinum group metal. The use of more than 1000 ppm of platinum group metal results in no appreciable increase in reaction rate, and is therefore uneconomical.

The concentration of organic solvent (e) is typically from 0 to 60% (w/w), alternatively from 30 to 60% (w/w), alternatively from 40 to 50% (w/w), based on the total weight of the reaction mixture.

The first carbazolyl-functional linear polysiloxane can be recovered from the reaction mixture by adding sufficient quantity of an alcohol to effect precipitation of the polysiloxane and then filtering the reaction mixture to obtain the polysiloxane. The alcohol typically has from 1 to 6 carbon atoms, alternatively from 1 to 3 carbon atoms. Moreover, the alcohol can have a linear, branched, or cyclic structure. The hydroxy group in the alcohol may be attached to a primary, secondary, or tertiary aliphatic carbon atom. Examples of alcohols include, but are not limited to, methanol, ethanol, 1-propanol, 2-propanol, 1-butanol, 2-butanol, 2-methyl-1-butanol, 1-pentanol, and cyclohexanol.

A second carbazolyl-functional linear polysiloxane according to the present invention comprises at least 30 mol % of units having the formula I and units having the formula IV: 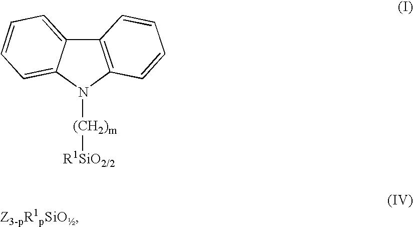
wherein R¹ is C₁ to C₁₀ hydrocarbyl free of aliphatic unsaturation; Z is a hydrolysable group; m is an integer from 2 to 10; and p is 0, 1, or 2. In formulae (I) and (IV), R¹, Z, and m are as defined and exemplified above for the first carbazolyl-functional linear polysiloxane.

The second carbazolyl-functional linear polysiloxane comprises at least 30 mol %, alternatively at least 70 mol %, alternatively at least 90 mol %, of units having formula (I). In addition to units having formulae (I) and (IV), above, the second carbazolyl-functional linear polysiloxane may contain up to 30 mol %, alternatively up to 15 mol %, alternatively up to 5 mol %, of other siloxane units. Examples of other siloxane units include, but are not limited to, units having the formulae: R¹HSiO_{2/2} and R¹₂SiO_{2/2}.

The second carbazolyl-functional linear polysiloxane typically has a number-average molecular weight of from 1,000 to 1,000,000, alternatively from 2,500 to 150,000, alternatively from 10,000 to 30,000, where the molecular weight is determined by gel permeation chromatography employing a low angle laser light scattering detector.

Examples of the second carbazolyl-functional linear polysiloxane include, but are not limited to, polysiloxanes having the following average formulae: Me(MeO)₂SiO[Si(Me)(CH₂CH₂CH₂Cz)O]_{c}Si(OMe)₂Me, Me(MeO)₂SiO[Si(Et)(CH₂CH₂CH₂Cz)O]_{c}Si(OMe)₂Me, Me(MeO)₂SiO[Si(Ph)(CH₂CH₂CH₂Cz)O]_{c}Si(OMe)₂Me, (AcO)₃SiO[Si(Me)(CH₂CH₂CH₂Cz)O]_{c}Si(OAc)₃, (AcO)₃SiO[Si(Et)(CH₂CH₂CH₂Cz)O]_{c}Si(OAc)₃, (AcO)₃SiO[Si(Ph)(CH₂CH₂CH₂Cz)O]_{c}Si(OAc)₃, (MeO)₃SiO[Si(Me)(CH₂CH₂CH₂Cz)O]_{c}Si(OMe)₃, (MeO)₃SiO[Si(Et)(CH₂CH₂CH₂Cz)O]_{c}Si(OMe)₃, and (MeO)₃SiO[Si(Ph)(CH₂CH₂CH₂Cz)O]_{c}Si(OMe)₃, where Cz is N-carbazolyl, Me is methyl, Ph is phenyl, OAc is acetoxy, and the subscript c has a value such that the polysiloxane has a number-average molecular weight of from 1,000 to 1,000,000.

The second carbazolyl-functional linear polysiloxane can be prepared by reacting (a′) an organohydrogenpolysiloxane having the formula Z₃₋ₚR¹ₚSiO(R¹HSiO)ₐSiR¹ₚZ₃₋ₚ with (b) an N-alkenyl carbazole having the formula Cz-(CH₂)ₘ₋₂—CH═CH₂ in the presence of (d) a hydrosilylation catalyst and, optionally, (e) an organic solvent, wherein the subscript a has a value such that the organohydrogenpolysiloxane has a number-average molecular weight of from 180 to 220,00, Cz is N-carbazolyl, and R¹, Z, m, and p are as defined and exemplified above for the second carbazolyl-functional linear polysiloxane.

Organohydrogenpolysiloxane (a′) has the formula Z₃₋ₚR¹ₚSiO(R¹HSiO)ₐSiR¹ₚZ₃₋ₚ, wherein R¹, Z, and p are as defined and exemplified above for the second carbazolyl-functional linear polysiloxane and the subscript a has a value such that the organohydrogenpolysiloxane has a number-average molecular weight of from 180 to 220,00, alternatively from 1,000 to 150,000, alternatively from 1,000 to 75,000.

Examples of organohydrogenpolysiloxanes suitable for use as organohydrogenpolysiloxane (a′) include, but are not limited to, trimethoxysiloxy-terminated poly(methylhydrogensiloxane)s, dimethoxymethylsiloxy-terminated poly(methylhydrogensiloxane)s, methoxydimethylsiloxy-terminated poly(methylhydrogensiloxane)s, triacetoxysiloxy-terminated poly(methylhydrogensiloxane)s, diacetoxymethylsiloxy-terminated poly(methylhydrogensiloxane)s, acetoxydimethylsiloxy-terminated poly(methylhydrogensiloxane)s, trimethoxysiloxy-terminated poly(ethylhydrogensiloxane)s, dimethoxymethylsiloxy-terminated poly(ethylhydrogensiloxane)s, methoxydimethylsiloxy-terminated poly(ethylhydrogensiloxane)s, triacetoxysiloxy-terminated poly(ethylhydrogensiloxane)s, diacetoxymethylsiloxy-terminated poly(ethylhydrogensiloxane)s, acetoxydimethylsiloxy-terminated poly(ethylhydrogensiloxane)s, trimethoxysiloxy-terminated poly(phenylhydrogensiloxane)s, dimethoxymethylsiloxy-terminated poly(phenylhydrogensiloxane)s, methoxydimethylsiloxy-terminated poly(phenylhydrogensiloxane)s, triacetoxysiloxy-terminated poly(phenylhydrogensiloxane)s, diacetoxymethylsiloxy-terminated poly(phenylhydrogensiloxane)s, and acetoxydimethylsiloxy-terminated poly(phenylhydrogensiloxane)s.

Methods of preparing organohydrogenpolysiloxanes having terminal hydrolysable groups are well known in the art. For example the organohydrogenpolysiloxanes can be prepared by reacting an alkoxy-terminated organohydrogenpolysiloxane with a silane having the formula XSiR¹ₚZ₃₋ₚ, wherein X is Z or —H, R¹, Z, and p are as defined above for the second carbazolyl-functional polysiloxane.

N-alkenyl carbazole (b), hydrosilylation catalyst (d), and organic solvent (e) are as described and exemplified above in the method of preparing the first carbazolyl-functional linear polysiloxane.

The reaction for preparing the second carbazolyl-functional linear polysiloxane can be carried out in the manner described above for preparing the first carbazolyl-functional linear polysiloxane, except the mole ratio of N-alkenyl carbazole (b) to silicon-bonded hydrogen atoms in organohydrogenpolysiloxane (a) is typically from 0.7 to 1.2, alternatively from 0.85 to 1.1. Furthermore, the second carbazolyl-functional linear polysiloxane can be recovered from the reaction mixture as described above for the first carbazolyl-functional linear polysiloxane.

A silicone composition according to the present invention comprises:

(A) a polysiloxane selected from (i) at least one carbazolyl-functional linear polysiloxane comprising from 30 to 99 mol % of units having the formula I, from 1 to 70 mol % of units having the formula II, and units having the formula III: 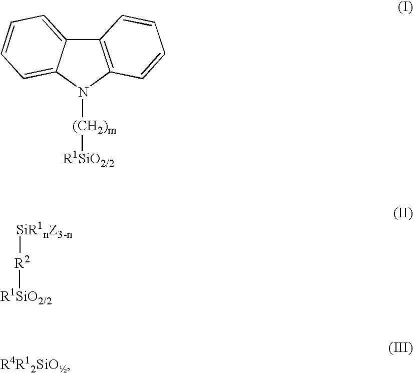
wherein R¹ is C₁ to C₁₀ hydrocarbyl free of aliphatic unsaturation, R² is —CH₂—CHR³— or —CH₂—CHR³—Y—, wherein Y is a divalent organic group and R³ is R¹ or —H, R⁴ is R¹, —(CH₂)ₘ-Cz, —CH₂—CHR³—SiR¹ₙZ₃₋ₙ, or —CH₂—CHR³—Y—SiR¹ₙZ₃₋ₙ, wherein Cz is N-carbazolyl, Z is a hydrolysable group, m is an integer from 2 to 10, and n is 0, 1, or 2, and (ii) at least one carbazolyl-functional linear polysiloxane comprising at least 30 mol % of units having the formula I and units having the formula IV:

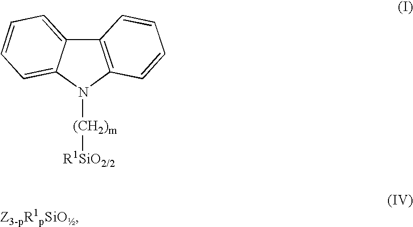

wherein R¹ is C₁ to C₁₀ hydrocarbyl free of aliphatic unsaturation, Z is a hydrolysable group, m is an integer from 2 to 10, and p is 0, 1, or 2, and (iii) a mixture comprising (i) and (ii); and

(B) an organic solvent.

Components (A)(i) and (A)(ii) are the first carbazolyl-functional linear polysiloxane and the second carbazolyl-functional linear polysiloxane, respectively, described and exemplified above.

Component (B) is at least one organic solvent. Examples of organic solvents include, but are not limited to, saturated aliphatic hydrocarbons such as n-pentane, hexane, n-heptane, isooctane and dodecane; cycloaliphatic hydrocarbons such as cyclopentane and cyclohexane; aromatic hydrocarbons such as benzene, toluene, xylene and mesitylene; cyclic ethers such as tetrahydrofuran (THF) and dioxane; ketones such as methyl isobutyl ketone (MIBK); halogenated alkanes such as trichloroethane; and halogenated aromatic hydrocarbons such as bromobenzene and chlorobenzene. Component (B) can be a single organic solvent or a mixture comprising two or more different organic solvents, each as defined above. The concentration of the organic solvent is typically from 70 to 99% (w/w), alternatively from 85 to 99% (w/w), based on the total weight of the silicone composition.

The silicone composition can further comprise at least one condensation catalyst. The condensation catalyst can be any condensation catalyst typically used to promote condensation of silicon-bonded hydroxy (silanol) groups to form Si—O—Si linkages. Examples of condensation catalysts include, but are not limited to, tin(II) and tin(IV) compounds such as tin dilaurate, tin dioctoate, and tetrabutyl tin; and titanium compounds such as titanium tetrabutoxide.

When present, the concentration of the condensation catalyst is typically from 0.1 to 10% (w/w), alternatively from 0.5 to 5% (w/w), alternatively from 1 to 3% (w/w), based on the total weight of component (A).

When the silicone composition comprises, component (A)(ii), wherein p has a value of 2, the composition typically further comprises a cross-linking agent having the formula R⁵_{q}SiZ_{4-q}, wherein R⁵ is C₁ to C₈ hydrocarbyl or halogen-substituted hydrocarbyl, Z is as described above for the second carbazolyl-functional linear polysiloxane and q is 0 or 1. Examples of cross-linking agents include, but are not limited to, alkoxy silanes such as MeSi(OCH₃)₃, CH₃Si(OCH₂CH₃)₃, CH₃Si(OCH₂CH₂CH₃)₃, CH₃Si[O(CH₂)₃CH₃]₃, CH₃CH₂Si(OCH₂CH₃)₃, C₆H₅Si(OCH₃)₃, C₆H₅CH₂Si(OCH₃)₃, C₆H₅Si(OCH₂CH₃)₃, CH₂═CHSi(OCH₃)₃, CH₂═CHCH₂Si(OCH₃)₃, CF₃CH₂CH₂Si(OCH₃)₃, CH₃Si(OCH₂CH₂OCH₃)₃, CF₃CH₂CH₂Si(OCH₂CH₂OCH₃)₃, CH₂═CHSi(OCH₂CH₂OCH₃)₃, CH₂═CHCH₂Si(OCH₂CH₂OCH₃)₃, C₆H₅Si(OCH₂CH₂OCH₃)₃, Si(OCH₃)₄, Si(OC₂H₅)₄, and Si(OC₃H₇)₄; organoacetoxysilanes such as CH₃Si(OCOCH₃)₃, CH₃CH₂Si(OCOCH₃)₃, and CH₂═CHSi(OCOCH₃)₃; organoiminooxysilanes such as CH₃Si[O—N═C(CH₃)CH₂CH₃]₃, Si[O—N═C(CH₃)CH₂CH₃]₄, and CH₂═CHSi[O—N═C(CH₃)CH₂CH₃]₃; organoacetamidosilanes such as CH₃Si[NHC(═O)CH₃]₃ and C₆H₅Si[NHC(═O)CH₃]₃; amino silanes such as CH₃Si[NH(s-C₄H₉)]₃ and CH₃Si(NHC₆H₁₁)₃; and organoaminooxysilanes.

The cross-linking agent can be a single silane or a mixture of two or more different silanes, each as described above. Also, methods of preparing tri- and tetra-functional silanes are well known in the art; many of these silanes are commercially available.

When present, the concentration of the cross-linking agent in the silicone composition is sufficient to cure (cross-link) the composition. The exact amount of the cross-linking agent depends on the desired extent of cure, which generally increases as the ratio of the number of moles of silicon-bonded hydrolysable groups in the cross-linking agent to the number of moles of hydrolysable groups Z in the second carbazolyl-functional linear polysiloxane increases. Typically, the concentration of the cross-linking agent is sufficient to provide from 0.9 to 1.0 silicon-bonded hydrolysable groups per hydrolysable group in the second carbazolyl-functional linear polysiloxane. The optimum amount of component (C) can be readily determined by routine experimentation.

The silicone composition of the instant invention is typically prepared by combining components (A) and (B) and any optional ingredients in the stated proportions at ambient temperature.

Mixing can be accomplished by any of the techniques known in the art such as milling, blending, and stirring, either in a batch or continuous process. The particular device is determined by the viscosity of the components and the viscosity of the final silicone composition.

A cured carbazolyl-functional polysiloxane according to the present invention is prepared by curing the silicone composition, described above. The silicone composition can be cured by exposing the composition to moisture at moderate temperature. Cure can be accelerated by application of heat and/or exposure to high humidity. The rate of cure depends on a number of factors, including temperature, humidity, structure of the carbazolyl-functional linear polysiloxane, and nature of the hydrolysable groups. For example, the silicone composition can be cured by exposing the composition to a relative humidity of about 30% at a temperature of from about room temperature (23° C.) to about 150° C., for period from 0.5 to 72 h.

An organic light-emitting diode according to the present invention comprises:

a substrate having a first opposing surface and a second opposing surface;

a first electrode layer overlying the first opposing surface;

a light-emitting element overlying the first electrode layer, the light emitting element comprising
a hole-transport layer and
an electron-transport layer, wherein the hole-transport layer and the electron-transport layer lie directly on one another, and one of the hole-transport layer and the electron-transport layer comprises a carbazolyl-functional polysiloxane selected from
   a cured carbazolyl-functional polysiloxane prepared by curing a silicone composition comprising (A) a polysiloxane selected from (i) at least one carbazolyl-functional linear polysiloxane comprising from 30 to 99 mol % of units having the formula I, from 1 to 70 mol % of units having the formula II, and units having the formula III: 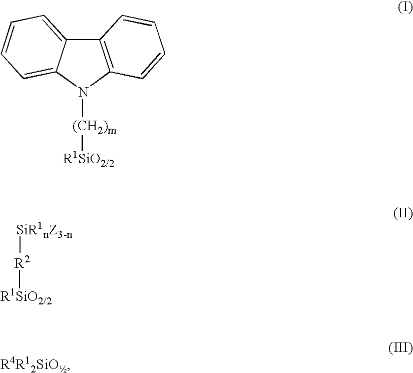
wherein R¹ is C₁ to C₁₀ hydrocarbyl free of aliphatic unsaturation, R² is —CH₂—CHR³— or —CH₂—CHR³—Y—, wherein Y is a divalent organic group and R³ is R¹ or —H, R⁴ is R¹, —(CH₂)ₘ-Cz, —CH₂—CHR³—SiR¹ₙZ₃₋ₙ, or —CH₂—CHR³—Y—SiR¹ₙZ₃₋ₙ, wherein Cz is N-carbazolyl, Z is a hydrolysable group, m is an integer from 2 to 10, nd n is 0, 1, or 2, (ii) at least one carbazolyl-functional linear polysiloxane comprising at least 30 mol % of units having the formula I and units having the formula IV: 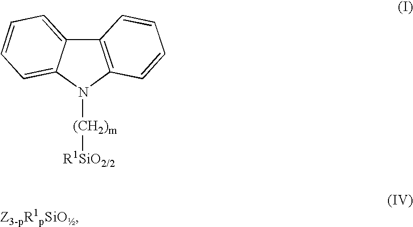
wherein R¹ is C₁ to C₁₀ hydrocarbyl free of aliphatic unsaturation, Z is a hydrolysable group, m is an integer from 2 to 10) and p is 0, 1, or 2, and (iii) a mixture comprising (i) and (ii), and (B) an organic solvent, and
   at least one carbazolyl-functional linear polysiloxane comprising at least 50 mol % of units having the formula I, and units having the formula V: 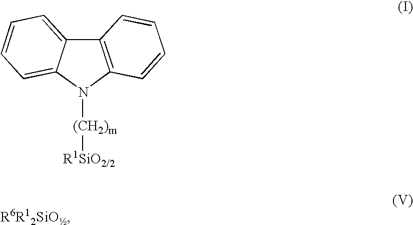
wherein R¹ is C₁ to C₁₀ hydrocarbyl free of aliphatic unsaturation, m is from 2 to 10, and R⁶ is R¹ or —(CH₂)ₘ-Cz, wherein Cz is N-carbazolyl; and

a second electrode layer overlying the light-emitting element.

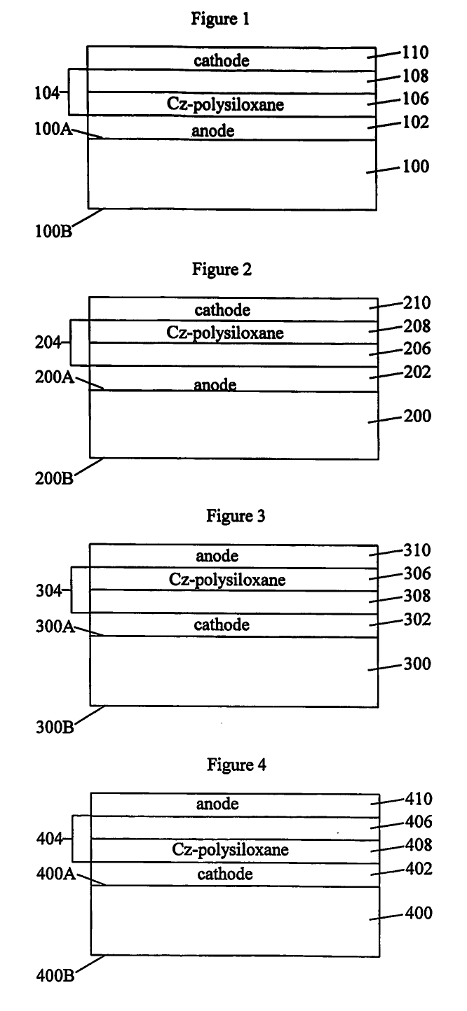

The term “overlying” used in reference to the position of the first electrode layer, light-emitting element, and second electrode layer relative to the designated component means the particular layer either lies directly on the component or lies above the component with one or more intermediary layers there between, provided the OLED is oriented with the substrate below the first electrode layer as shown in FIGS. 1-4. For example, the term “overlying” used in reference to the position of the first electrode layer relative to the first opposing surface of the substrate in the OLED means the first electrode layer either lies directly on the surface or is separated from the surface by one or more intermediate layers.

The substrate can be a rigid or flexible material having two opposing surfaces. Further, the substrate can be transparent or nontransparent to light in the visible region of the electromagnetic spectrum. As used herein, the term “trtnsparent” means the particular component (e.g., substrate or electrode layer) has a percent transmittance of at least 30%, alternatively at least 60%, alternatively at least 80%, for light in the visible region (˜400 to ˜700 nm) of the electromagnetic spectrum. Also, as used herein, the term “nontransparent” means the component has a percent transmittance less than 30% for light in the visible region of the electromagnetic spectrum.

Examples of substrates include, but are not limited to, semiconductor materials such as silicon, silicon having a surface layer of silicon dioxide, and gallium arsenide; quartz; fused quartz; aluminum oxide; ceramics; glass; metal foils; polyolefins such as polyethylene, polypropylene, polystyrene, and polyethyleneterephthalate; fluorocarbon polymers such as polytetrafluoroethylene and polyvinylfluoride; polyamides such as Nylon; polyimides; polyesters such as poly(methyl methacrylate); epoxy resins; polyethers; polycarbonates; polysulfones; and polyether sulfones.

The first electrode layer can function as an anode or cathode in the OLED. The first electrode layer may be transparent or nontransparent to visible light. The anode is typically selected from a high work-function (>4 eV) metal, alloy, or metal oxide such as indium oxide, tin oxide, zinc oxide, indium tin oxide (ITO), indium zinc oxide, aluminum-doped zinc oxide, nickel, and gold. The cathode can be a low work-function (<4 eV) metal such as Ca, Mg, and Al; a high work-function (>4 eV) metal, alloy, or metal oxide, as described above; or an alloy of a low-work function metal and at least one other metal having a high or low work-function, such as Mg—Al, Ag—Mg, Al—Li, In—Mg, and Al—Ca. Methods of depositing anode and cathode layers in the fabrication of OLEDs, such as evaporation, co-evaporation, DC magnetron sputtering, or RF sputtering, are well known in the art.

The light-emitting element comprises a hole-transport layer and an electron-transport layer wherein the hole-transport layer and the electron-transport layer lie directly on one another, and one of the hole-transport layer and the electron-transport layer comprises a carbazolyl-functional polysiloxane, described below. The orientation of the light-emitting element depends on the relative positions of the anode and cathode in the OLED. The hole-transport layer is located between the anode and the electron-transport layer and the electron-transport layer is located between the hole-transport layer and the cathode. The thickness of the hole-transport layer is typically from 20 to 100 nm, alternatively from 30 to 50 nm. The thickness of the electron-transport layer is typically from 20 to 100 nm, alternatively from 30 to 50 nm.

The carbazolyl-functional polysiloxane of the OLED can be a cured carbazolyl-functional polysiloxane prepared by curing a silicone composition comprising a polysiloxane selected from the first carbazolyl-functional linear polysiloxane, the second carbazolyl-functional linear polysiloxane, and a mixture thereof, and an organic solvent. The silicone composition and methods of curing the composition are as described above.

Alternatively, the carbazolyl-functional polysiloxane of the OLED can be a carbazolyl-functional linear polysiloxane comprising at least 50 mol % of units having the formula I, and units having the formula V: 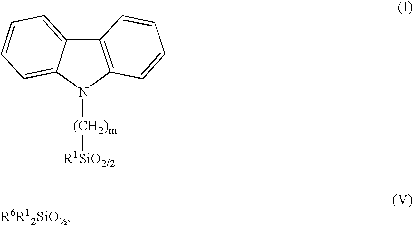
wherein R⁶ is R¹ or —(CH₂)ₘ-Cz, wherein Cz is N-carbazolyl, and R¹ and m are as defined and exemplified above for the first carbazolyl-functional linear polysiloxane.

The carbazolyl-functional linear polysiloxane comprises at least 50 mol %, alternatively at least 70 mol %, alternatively at least 90 mol %, of units having formula (I). In addition to units having formulae (I) and (III), above, the carbazolyl-functional linear polysiloxane may contain up to 30 mol %, alternatively up to 15 mol %, alternatively up to 5 mol %, of other siloxane units. Examples of other siloxane units include, but are not limited to, units having the formulae: R¹HSiO_{2/2}, HR¹₂SiO_{1/2}, and R¹₂SiO_{2/2}.

The carbazolyl-function polysiloxane typically has a number-average molecular weight of from 1,000 to 1,000,000, alternatively from 2,500 to 150,000, alternatively from 10,000 to 30,000, where the molecular weight is determined by gel permeation chromatography employing a low angle laser light scattering detector.

Examples of carbazolyl-functional linear polysiloxanes include, but are not limited to, polysiloxanes having the following average formulae: Me₃SiO[Si(Me)(CH₂CH₂CH₂Cz)O]_{c}SiMe₃, Et₃SiO[Si(Me)(CH₂CH₂CH₂Cz)O]_{c}SiEt₃, Me₃SiO[Si(Et)(CH₂CH₂CH₂Cz)O]_{c}SiMe₃, Et₃SiO[Si(Et)(CH₂CH₂CH₂Cz)O]_{c}SiEt₃, Me₃SiO[Si(Ph)(CH₂CH₂CH₂Cz)O]_{c}SiMe₃, Et₃SiO[Si(Ph)(CH₂CH₂CH₂Cz)O]_{c}SiEt₃, and PhMe₂SiO[Si(Me)(CH₂CH₂CH₂Cz)O]_{c}SiMe₂Ph, wherein Cz is N-carbazolyl, Me is methyl, Et is ethyl, Ph is phenyl, and the subscript c has a value such that the polysiloxane has a number-average molecular weight of from 1,000 to 1,000,000.

The carbazolyl-functional polysiloxane can be prepared by reacting (a) an organohydrogenpolysiloxane having the formula R³R¹₂SiO(R¹HSiO)ₐSiR¹₂R³ with (b) an N-alkenyl carbazole having the formula Cz-(CH₂)ₘ₋₂—CH═CH₂ in the presence of (d) a hydrosilylation catalyst and, optionally, (e) an organic solvent, wherein organohydrogenpolysiloxane (a) and components (b), (d), and (e) are as described and exemplified above in the method of preparing the first carbazolyl-functional linear polysiloxane.

The reaction for preparing the carbazolyl-functional linear polysiloxane can be carried out in the manner described above for preparing the first carbazolyl-functional linear polysiloxane, except the mole ratio of N-alkenyl carbazole (b) to silicon-bonded hydrogen atoms in organohydrogenpolysiloxane (a) is typically from 0.7 to 1.2, alternatively from 0.85 to 1.1. Furthermore, the carbazolyl-functional linear polysiloxane can be recovered from the reaction mixture as described above for the first carbazolyl-functional linear polysiloxane.

The silicone composition used to prepare the cured carbazolyl-functional polysiloxane, and the carbazolyl-functional linear polysiloxane can be applied to the first electrode layer, the hole-transport layer, or the electron-transport layer, depending on the configuration of the OLED, using conventional methods such as spin-coating, dipping, spraying, brushing, and printing. The carbazolyl-functional liner polysiloxane can also be dissolved in an organic solvent prior to application, where the organic solvent is as described above for the silicone composition of the invention.

When the hole-transport layer is a carbazolyl-functional polysiloxane, the electron-transport layer can be any low molecular weight organic compound or organic polymer typically used as an electron-transport, electron-injection/electron-transport, or light-emitting material in OLED devices. Low molecular weight organic compounds suitable for use as the electron-transport layer are well known in the art, as exemplified in U.S. Pat. No. 5,952,778; U.S. Pat. No. 4,539,507; U.S. Pat. No. 4,356,429; U.S. Pat. No. 4,769,292; U.S. Pat. No. 6,048,573; and U.S. Pat. No. 5,969,474. Examples of low molecular weight compounds include, but are not limited to, aromatic compounds, such as anthracene, naphthalene, phenanthrene, pyrene, chrysene, and perylene; butadienes such as 1,4-diphenylbutadiene and tetraphenylbutadiene; coumarins; acridine; stilbenes such as trans-stilbene; and chelated oxinoid compounds, such as tris(8-hydroxyquinolato)aluminum(III), Alq₃. These low molecular weight organic compounds may be deposited by standard thin-film preparation techniques including vacuum evaporation and sublimation.

Organic polymers suitable for use as the electron-transport layer are well known in the art, as exemplified in U.S. Pat. No. 5,952,778; U.S. Pat. No. 5,247,190; U.S. Pat. No. 5,807,627; U.S. Pat. No. 6,048,573; and U.S. Pat. No. 6,255,774. Examples of organic polymers include, but are not limited to, poly(phenylene vinylene)s, such as poly(1,4 phenylene vinylene); poly-(2,5-dialkoxy-1,4 phenylene vinylene)s, such as poly(2-methoxy-5-(2-ethylhexyloxy)-1,4-phenylenevinylene) (MEHPPV), poly(2-methoxy-5-(2-methylpentyloxy)-1,4-phenylenevinylene), poly(2-methoxy-5-pentyloxy-1,4-phenylenevinylene), and poly(2-methoxy-5-dodecyloxy-1,4-phenylenevinylene); poly(2,5-dialkyl-1,4 phenylene vinylene)s; poly(phenylene); poly(2,5-thalkyl-1,4 phenylene)s; poly(p-phenylene); poly(thiophene)s, such as poly(3-alkylthiophene)s; poly(alkylthienylene)s, such as poly(3-dodecylthienylene); poly(fluorene)s, such as poly(9,9-dialkyl fluorine)s; and polyanilines. The organic polymers can be applied by conventional solvent coating techniques such as spin-coating, dipping, spraying, brushing, and printing (e.g., stencil printing and screen printing).

When the electron-transport layer is a carbazolyl-functional polysiloxane, the hole-transport layer can be any organic compound typically used as a hole-transport, hole-injection, or hole-injection/hole-transport material in OLED devices. Organic compounds suitable for use as the hole-transport layer are well known in the art, as exemplified in U.S. Pat. No. 4,720,432; U.S. Pat. No. 5,593,788; U.S. Pat. No. 5,969,474; U.S. Pat. No. 4,539,507; U.S. Pat. No. 6,048,573; and U.S. Pat. No. 4,888,211. Examples of organic compounds include, but are not limited to, aromatic tertiary amines, such as monoarylamines, diarylamines, triarylamines, and tetraaryldiamines; hydrazones; carbazoles; triazoles; imidazoles; oxadiazoles having an amino group; polythiophenes, such as poly(3,4-ethylenedioxythiophene) poly(styrenesulfonate), which is sold under the name Baytron® P by H.C. Starck Inc.; and porhyrinic compounds, such as phthalocyanines and metal-containing phthalocyanines. The organic compounds can be applied by conventional thin-film preparation techniques including vacuum evaporation and sublimation.

The electron-transport layer or the hole-transport layer in the light-emitting layer in the light-emitting element can further comprise a fluorescent dye. Fluorescent dyes suitable for use in OLED devices are well known in the art, as illustrated in U.S. Pat. No. 4,769,292. Examples of fluorescent dyes include, but are not limited to, coumarins; dicyanomethylenepyrans, such as 4-(dicyanomethylene)-2-methyl-6-(p-dimethylaminostyryl)4H-pyran; dicyanomethylenethiopyrans; polymethine; oxabenzanthracene; xanthene; pyrylium and thiapyrylium; cabostyril; and perylene fluorescent dyes.

The second electrode layer can function either as an anode or cathode in the OLED. The second electrode layer may be transparent or nontransparent to light in the visible region. Examples of anode and cathode materials and methods for their formation are as described above for the first electrode layer.

The OLED of the present invention can further comprise a hole-injection layer interposed between the anode and the hole-transport layer, and/or an electron-injection layer interposed between the cathode and the electron-transport layer. The hole-injection layer typically has a thickness of from 5 to 20 nm, alternatively from 7 to 10 nm. Examples of materials suitable for use as the hole-injection layer include, but are not limited to, copper phthalocyanine. The electron-injection layer typically has a thickness of from 0.5 to 5 nm, alternatively from 1 to 3 nm. Examples of materials suitable for use as the electron-injection layer include, but are not limited to, alkali metal fluorides, such as lithium fluoride and cesium fluoride; and alkali metal carboxylates, such as lithium acetate and cesium acetate. The hole-injection layer and the hole-injection layer can be formed by conventional techniques, thermal evaporation.

As shown in FIG. 1, a first embodiment of an OLED according to the present invention comprises a substrate 100 having a first opposing surface 100A and a second opposing surface 100B, a first electrode layer 102 on the first opposing surface 100A, wherein the first electrode layer 102 is an anode, a light-emitting element 104 overlying the first electrode layer 102, wherein the light-emitting element 104 comprises a hole-transport layer 106 and an electron-transport layer 108 lying directly on the hole-transport layer 106, wherein the hole-transport layer 106 comprises a carbazolyl-functional polysiloxane, and a second electrode layer 110 overlying the light-emitting element 104, wherein the second electrode layer 110 is a cathode.

As shown in FIG. 2, a second embodiment of an OLED according to the present invention comprises a substrate 200 having a first opposing surface 200A and a second opposing surface 200B, a first electrode layer 202 on the first opposing surface 200A, wherein the first electrode layer 202 is an anode, a light-emitting element 204 overlying the first electrode layer 202, wherein the light-emitting element 204 comprises a hole-transport layer 206 and an electron-transport layer 208 lying directly on the hole-transport layer 206, wherein the electron-transport layer 208 comprises a carbazolyl-functional polysiloxane, and a second electrode layer 210 overlying the light-emitting element 204, wherein the second electrode layer 210 is a cathode.

As shown in FIG. 3, a third embodiment of an OLED according to the present invention comprises a substrate 300 having a first opposing surface 300A and a second opposing surface 300B, a first electrode layer 302 on the first opposing surface 300A, wherein the first electrode layer 302 is a cathode, a light-emitting element 304 overlying the first electrode layer 302, wherein the light-emitting element 304 comprises an electron-transport layer 308 and a hole-transport layer 306 lying directly on the electron-transport layer 306, wherein the hole-transport layer 306 comprises a carbazolyl-functional polysiloxane, and a second electrode layer 310 overlying the light-emitting element 304, wherein the second electrode layer 310 is an anode.

As shown in FIG. 4, a fourth embodiment of an OLED according to the present invention comprises a substrate 400 having a first opposing surface 400A and a second opposing surface 400B, a first electrode layer 402 on the first opposing surface 400A, wherein the first electrode layer 402 is a cathode, a light-emitting element 404 overlying the first electrode layer 402, wherein the light-emitting element 404 comprises an electron-transport layer 408 and a hole-transport layer 406 lying directly on the electron-transport layer 408, wherein the electron-transport layer 408 comprises a carbazolyl-functional polysiloxane, and a second electrode layer 410 overlying the light-emitting element 404, wherein the second electrode layer 410 is an anode.

The carbazolyl-functional linear polysiloxanes of the present invention exhibit electroluminescence, emitting light when subjected to an applied voltage. Moreover, the linear polysiloxanes contain hydrolysable groups and can be cured to produce durable cross-linked polysiloxanes. Also, the linear polysiloxanes can be doped with small amounts of fluorescent dyes to enhance the electroluminescent efficiency and control the color output of the cured polysiloxanes.

The silicone composition of the present invention can be conveniently formulated as a one-part composition. Moreover, the silicone composition has good shelf-stability in the absence of moisture. Importantly, the composition can be applied to a substrate by conventional high-speed methods such as spin coating, printing, and spraying. Also, the silicone composition can be readily cured by exposure to moisture at mild to moderate temperatures.

The cured carbazolyl-functional polysiloxane prepared by curing the silicone composition of the present invention exhibits electroluminescence. Moreover, the cured polysiloxane has good primeness adhesion to a variety of substrates. The cured polysiloxane also exhibits excellent durability, chemical resistance, and flexibility at low temperatures. Additionally, the cured polysiloxane exhibits high transparency, typically at least 95% transmittance at a thickness of 100 nm, in the visible region of the electromagnetic spectrum. Importantly, the polysiloxane is substantially free of acidic or basic components, which are detrimental to the electrode and light-emitting layers in OLED devices.

The OLED of the present invention exhibits good resistance to abrasion, organic solvents, moisture, and oxygen. Moreover, the OLED exhibits high quantum efficiency and photostability.

The OLED is useful as a discrete light-emitting device or as the active element of light-emitting arrays or displays, such as flat panel displays. OLED displays are useful in a number of devices, including watches, telephones, lap-top computers, pagers, cellular phones, digital video cameras, DVD players, and calculators.

### EXAMPLES

The following examples are presented to better illustrate the carbazolyl-functional linear polysiloxanes, silicone composition, and OLED of the present invention, but are not to be considered as limiting the invention, which is delineated in the appended claims. Unless otherwise noted, all parts and percentages reported in the examples are by weight. The following methods and materials were employed in the examples:

Infrared Spectra

Infrared spectra of carbazolyl-functional linear polysiloxanes were recorded on a Perkin Elmer Instruments 1600 FT-IR spectrometer. An aliquot of a reaction mixture containing the polysiloxane was dissolved in TBF or toluene to achieve a concentration of approximately 10%. A drop of the solution was applied to a NaCl window and the solvent was evaporated under a stream of dry nitrogen to form a thin film of the polysiloxane.

NMR Spectra

Nuclear magnetic resonance spectra (¹³C NMR, ²⁹Si NMR) of carbazolyl-functional linear polysiloxanes were obtained using a Varian Mercury 400 MHz NMR spectrometer. The polysilane (0.5-1.0 g) was dissolved in 2.5-3 mL of chloroform-d in a 0.5 oz glass vial. The solution was transferred to a Teflon NMR tube and 3-4 mL of a solution of Cr(acac)₃ in chloroform-d (0.04 M) was added to the tube. The chemical shift values (δ) reported in the examples are in units of parts per million (ppm), measured relative to CDCl₃ in the ¹³C NMR spectra and relative to tetramethylsilane in the ²⁹Si NMR spectra.

Thermal Stability

The thermal stability of carbazolyl-functional linear polysiloxanes was determined by thermal gravimetric analysis (TGA) using a TA Instruments Auto TGA 2950HR analyzer. A sample of the polysiloxane was heated from 0 to 1,000° C. at 10° C./min in air or helium and the resultant mass loss for the polysiloxane was determined from the thermogram. The temperature at which the mass loss exceeded 10% was taken as the decomposition temperature of the polysiloxane.

Film Thickness

The thickness of carbazolyl-functional polysiloxane films and polymer films was determined using a KLA-Tencor AS-500 surface profiler. Before measurement, a section of the film (2-3 mm wide and 4-5 mm long) was removed, exposing the substrate. Film thickness was measured at the step between the coated and uncoated surfaces of the substrate. The reported values for thickness, expressed in units of microns (μm), represent the average of three measurements performed on different regions of the same substrate.

Refractive Index

The refractive index of carbazolyl-functional linear polysiloxane films on silicon wafers was determined using a J. A. Woollam VVASE ellipsometer. A solution (<0.5 mL) of the polysiloxane in anhydrous toluene (1.25% w/w) was passed though a syringe filter (0.1 μm), deposited on a silicon wafer (10.2 cm.), and cast into a thin film using a CHEMAT Technology KW-4A spin-coater (3,000 rpm, 20 seconds). The refractive index was determined at 23° C. for light having a wavelength of 589 nm.

Transmittance

The UV-Visible absorption spectra (250 to 800 nm) of carbazolyl-functional linear polysiloxane films on glass substrates were determined using an Optical Solutions PS-2 portable diode array spectrophotometer system. A solution of the carbazole-functional polysiloxane in anhydrous toluene (3%) was passed though a syringe filter (0.1 μm), deposited on a glass slide (25 mm×25 mm) and cast into a thin film using a CHEMAT Technology Model KW-4A spin-coater (3000 rpm, 20 seconds). The percent transmittance of the polysiloxane film was determined from the spectral curve.

Photoluminescent Spectra

The photoluminescent excitation and emission spectra of carbazolyl-functional linear polysiloxanes in toluene (0.1%) were determined using a SPEX 1681 Fluorolog II Single Grating Spectrofluorometer equipped with a Xenon lamp. The excitation spectrum was collected at an emission wavelength of 370 nm. The emission spectrum was collected at an excitation wavelength of 340 nm. From these spectra, the wavelengths at maximum emission (λ_{max, em}) and maximum excitation (λ_{max, ex}) were determined for the polysiloxane.

Solvent Resistance

The solvent resistance of cured carbazolyl-functional polysiloxane films was determined by immersing a substrate coated with the film in THF for two minutes. Solvent resistance was determined by comparing film quality (e.g., swelling, adhesion) and film thickness before and after immersion in THF.

Method of Cleaning ITO-Coated Glass Substrates

ITO-coated glass slides (Thin Film Technology, Inc., Buellton, Calif.) having a surface resistance of 10 Ω/square were cut into 25-mm square substrates. The substrates were immersed in an ultrasonic bath containing a solution consisting of 1% Alconox powdered cleaner (Alconox, Inc.) in water for 10 min and then rinsed with deionized water. The substrates were then immersed sequentially in the each of the following solvents with ultrasonic agitation for 10 min in each solvent: isopropyl alcohol, n-hexane, and toluene. The glass substrates were then dried under a stream of dry nitrogen.

Formation of Polysiloxane Films in OLEDS

Carbazolyl-functional polysiloxane films in OLEDs were formed by depositing a solution of the polysiloxane on the desired layer and casting it into a thin film using a CHEMAT Technology Model KW-4A spin-coater operating at a speed of 3000 rpm for 20 seconds.

Deposition of Organic Films and SiO in OLEDs

Organic films prepared from low molecular weight organic compounds (e.g., copper phthalocyanine and Alq₃) and silicon monoxide (SiO) were deposited by thermal evaporation using a BOC Edwards Auto 306 high vacuum deposition system equipped with a crystal balance film thickness monitor. The substrate was placed in a rotary sample holder positioned above the source and covered with the appropriate mask. The source was prepared by placing a sample of the organic compound or SiO in an aluminum oxide crucible. The crucible was then positioned in a tungsten wire spiral. The pressure in the vacuum chamber was reduced to 2.0×10⁻⁶ mbar. The substrate was allowed to outgas for at least 30 minutes at this pressure. The organic or SiO film was deposited by heating the source via the tungsten filament while rotating the sample holder. The deposition rate (0.1 to 0.3 nm per second) and the thickness of the film were monitored during the deposition process.

Organic films prepared from polymers, e.g., poly(3,4-ethylenedioxythiophene) poly(styrenesulfonate), were formed by depositing a solution of the polymer on the desired layer and casting it into a thin film using a CHEMAT Technology Model KW-4A spin-coater operating at a speed of 3000 rpm for 20 seconds.

Deposition of Metal Films in OLEDs

Metal and metal alloy films (e.g., Ca, Al, and LiF) were deposited by thermal evaporation under an initial vacuum of 10⁻⁶ mbar using a BOC Edwards model E306A Coating System equipped with a crystal balance film thickness monitor. The source was prepared by placing the metal in an aluminum oxide crucible and positioning the crucible in a tungsten wire spiral, or by placing the metal directly in a tungsten basket. When multiple layers of different metals were required, the appropriate sources were placed in a turret that could be rotated for deposition of each metal. The deposition rate (0.1 to 0.3 nm per second) and the thickness of the film were monitored during the deposition process.

Turn-On Voltage, Brightness, and Relative Efficiency

A sample chamber was constructed using a black plastic box connected to a dry nitrogen line. A sample holder in the box had 5 metal contact pins matching the relative positions of the OLED electrodes on the glass substrates. These metal pins were connected to a Keithley 2400 source meter, through which a given voltage (0.5 V) was applied and the current was measured. In front of the OLED, a photodiode detector was mounted in alignment with the OLED. The photodiode was connected with an International Light IL1700 Radiometer that measured the signal produced by the photodiode. Brightness and relative efficiency were measured at 14 V and 500 cd/cm², respectively.

Electroluminescent Spectra of OLEDs

Electroluminescent spectra of OLEDs were determined using a Fluorlog II Single Grating Spectrofluorometer. The OLED was fixed in the center of the sample chamber of the spectrofluorometer and the excitation source was covered with a black panel during the measurement. A voltage was applied to the OLED using a source meter, and the spectrum of emitted light from the OLED was recorded with the spectrofluorometer. From a plot of intensity versus wavelength, the wavelength (λₘₐₓ) of emitted light at maximum intensity and the half-peak width (PW₅₀) at maximum intensity were measured for the OLED.

### Example 1

### Preparation of Poly[3-(N-carbazolyl)propylmethylsiloxane]

N-Allylcarbazole (11.40 g, 0.055 mol), a trimethylsiloxy-terminated poly(methylhydrogensiloxane) having a degree of polymerization (dp) of 115 in an amount sufficient to provide 0.05 mol of silicon-bonded hydrogen atoms, and 10 g of anhydrous toluene were combined in a dry flask equipped with a magnetic stirrer, nitrogen inlet, and thermometer. A solution consisting of 62% of 1,3-divinyl-1,1,3,3-tetramethyldisiloxane and 38% of a platinum(IV) complex of 1,3-divinyl-1,1,3,3-tetramethyldisiloxane was added to the mixture in an amount sufficient to achieve a platinum concentration of 10 ppm. The flask was placed into an oil bath at 60° C. and the progress of the reaction was monitored by periodically withdrawing an aliquot of the mixture for FTIR analysis. When the Si—H absorption at 2100-2200 cm⁻¹ was no longer evident, the solvent was removed by venting the flask, continuously purging the system with nitrogen, and heating the mixture at 110-140° C.

The crude product was dissolved in a minimal amount of anhydrous toluene and the carbazolyl-functional polysiloxane was precipitated by addition of high purity methanol. The dissolution/precipitation process was repeated three times. The final precipitate was extracted once with electronic grade hexane. The precipitate was heated at 140-150° C. in a vacuum oven under argon until a melt formed. Heating was continued at 140-150° C. under vacuum (˜133 pa) for 2 h. The title compound was obtained as a transparent solid.

The ¹³C NMR spectrum of the product shows signals at 22.3 ppm and 14.6 ppm, corresponding to the Si —CH₂—CH₂ group. The ²⁹Si NMR spectrum confirms the absence of Si—H groups, which appear at −36 ppm in the poly(methylhydrogensiloxane). TGA results indicate the polysiloxane has a decomposition temperature of 380° C. in air and 420° C. in helium. The optical properties of the carbazolyl-functional polysiloxane and thin films prepared from the polysiloxane are shown in Table 1.

### Example 2

### Preparation of Poly[3-(N-carbazolyl)propylethylsiloxane]

The title compound was prepared using the method of example 1, except a trimethylsiloxy-terminated poly(ethylhydrogensiloxane) having a viscosity of 75 to 125 cSt 25° C. was substituted for the poly(methylhydrogensiloxane) and the reaction mixture was heated at 60° C. for 2 h before removal of the solvent. The IR spectrum of the mixture showed a weak absorption at 2141 cm⁻¹, indicating the presence of 1-5 mol % of residual Si—H groups in the polysiloxane product.

The ¹³C NMR spectrum of the product shows signals at 22.3 ppm and 14.6 ppm, corresponding to the Si —CH₂—CH₂ groups. The ²⁹Si NMR shows a weak signal at −36.3 ppm, confirming the presence of residual Si—H groups. TGA results indicate the polysiloxane has decomposition temperature of 380° C. in air and 420° C. in helium. The optical properties of the carbazolyl-functional polysiloxane and thin films prepared from the polysiloxane are shown in Table 1.

TABLE 1

| | Thick- | Film | Transmit- | Polymer Properties | |
|---|---|---|---|---|---|
| Exam- | ness | Properties | tance | Emission | Excitation |
| ple | (nm) | RI n_{D}²⁰ | (%) | λ_{max, em}(nm) | λ_{max, ex}(nm) |
| 1 | 90 | 1.63 | 96.5 | — | — |
| 2 | 93 | 1.62 | 97.4 | 355 | 380 (415)* |

— Denotes property not measured.
*Wavelength of shoulder peak in plot of intensity versus wavelength.

### Example 3

### Preparation of Poly{[3-(N-carbazolyl)propylethylsiloxane]-co-[2-(trimethyoxysilylpropyloxycarbonyl)-2-methylethylsiloxane]}

N-Allylcarbazole (4.92 g, 0.024 mol), 1.5 g of a trimethylsiloxy-terminated poly(methylhydrogensiloxane) having a dp of 115, 0.3 g (1.2 mmol) of 3-methacryloyloxypropyltrimethoxysilane, and 6 g anhydrous toluene were combined in a flask under nitrogen. After thorough mixing, 0.06 g of a solution consisting of 0.31% of 1,3-divinyl-1,1,3,3-tetramethyldisiloxane and 0.19% of a platinum(IV) complex of 1,3-divinyl-1,1,3,3-tetramethyldisiloxane in 2-propanol was added to the mixture using a syringe. The flask was placed in an oil bath at 80° C. for 4 h. A second portion of 3-methacryloyloxypropyltrimethoxysilane (0.3 g, 1.2 mmol) was added to the mixture. After heating the mixture for an additional 2 h at 80° C., 1.0 g (4.8 mmol) of N-allylcarbazole was added to the mixture. The solvent was removed by venting the flask, continuously purging the system with nitrogen, and heating the mixture at 110-140° C.

Electronic grade hexane (20 mL) was added to the flask to extract any un-reacted N-allylcarbazole. The crude product was dissolved in a minimal amount of anhydrous toluene and the carbazolyl-functional linear polysiloxane was precipitated by addition of 20 mL of methanol. The dissolution/precipitation process was repeated three times. The remaining solid was dissolved in about 11 mL of anhydrous toluene to produce a concentrated stock solution having a solid content of 41.6%.

### Example 4

### Preparation of Poly[3-(N-carbazolyl)propylethylsiloxane-co-(methyldiacetoxysilyl)ethylethylsiloxane]

N-Allylcarbazole (9.33 g, 0.045 mole), (0.94 g, 0.005 mole) of diacetoxymethylvinylsilane, a trimethylsiloxy-terminated poly(ethylhydrogensiloxane) having a viscosity of 75-125 cSt at 25° C. in an amount sufficient to provide 0.05 mol of silicon-bonded hydrogen atoms, and 10 g of anhydrous toluene were combined in a dry flask equipped with a magnetic stirrer, nitrogen inlet, and thermometer. A solution of consisting of 62% of 1,3-divinyl-1,1,3,3-tetramethyldisiloxane and 38% of a platinum(IV) complex of 1,3-divinyl-1,1,3,3-tetramethyldisiloxane was added to the mixture in an amount sufficient to achieve a platinum concentration of 10 ppm. The flask was placed into an oil bath at 60° C. and the progress of the reaction was monitored by periodically withdrawing an aliquot of the mixture for FTIR analysis. When the intensity of the Si—H absorption at 2100-2200 cm⁻¹ remained constant, 2.07 g (0.01 mmol) of N-allylcarbazole was added to the mixture, which was then heated at 60° C. for an additional 1 h. When there was no change in the intensity of the Si—H absorption, the solvent was removed by venting the flask, continuously purging the system with nitrogen, and heating the mixture at 110° C. The crude product was subjected to the dissolution/precipitation procedure of Example 3. The remaining solid was dissolved in anhydrous toluene to produce a stock solution having a solid content of 5%.

### Example 5

### Preparation of Poly[3-(N-carbazolyl)propylethylsiloxane-co-(Triacetoxysilyl)ethylethylsiloxane]

The title compound was prepared using the method of Example 4, except 1.16 g (0.005 mole) of triacetoxyvinylsilane was substituted for the diacetoxymethylvinylsilane. The solid product was dissolved in anhydrous toluene to produce a stock solution having a solid content of 5%.

### Example 6

### Thin film of cured Poly[3-(N-carbazolyl)propylethylsiloxane-co-(methyldiacetoxysilyl)ethylethylsiloxane]

One drop of a solution of a solution consisting of 1.5% of poly[3-(N-carbazolyl)propylethylsiloxane-co-(methyldiacetoxysilyl)ethylethylsiloxane] in toluene was applied to a polished surface of a silicon wafer. The solvent was evaporated under nitrogen to produce a film having a thickness of 13 μm. An FTIR spectrum of the film (on wafer) showed a carbonyl absorption (1720 cm⁻¹). The film was heated in an oven at 100° C. for 42 hours and then at 150° C. for 23 hours, after which time the absorption corresponding to the carbonyl absorption was absent from the FTIR spectrum. Comparison of the film thickness before and after curing indicated shrinkage of 8%. The film exhibited good resistance to THF, showing no erosion (loss of film thickness, swelling, or peeling) after immersion in the solvent for 2 min.

### Example 7

### Thin films of Poly[3-N-carbazolyl)propylethylsiloxane-co-(Triacetoxysilyl)ethylethylsiloxane]

A silicone base composition was prepared by dissolving 1.5 parts of poly[3-(N-carbazolyl)propylmethylsiloxane-co-(triacetoxysilyl)ethylethylsiloxane] in 98.5 parts of anhydrous toluene. Three additional compositions were prepared by combining individual samples of the base composition with one of the following three catalysts to achieve a catalyst concentration of 0.0015%: tetramethylammonium hydroxide, tin(II) dioctoate, titanium(IV) isopropoxide. Each composition was deposited on a pre-cleaned glass substrate and cast into a film by spin-coating at 3,000 rpm for 20 s. The films were then exposed to moist air (900 g water/cm³) in a sealed (vacuum) oven for 2 h at 150° C., and then heated at the same temperature in ambient air for 2 h. Films prepared from compositions containing the tin and titanium catalysts showed no erosion (loss of film thickness, swelling, or peeling) after immersion in THF for 2 min. Films prepared from the compositions containing the tin and titanium catalysts exhibited good resistance to TBF, showing no erosion (loss of film thickness, swelling, or peeling) after immersion in the solvent for 2 min. Films prepared from the base composition and the composition containing tetramethylammonium hydroxide were completely removed from the substrate by THF.

### Example 8

Four OLEDs (see figures below) were fabricated as follows: Silicon monoxide (100 nm) was thermally deposited along a first edge of a pre-cleaned ITO-coated glass substrate (25 mm×25 mm) through a mask having a rectangular aperture (6 mm×25 mm). A strip of 3M Scotch brand tape (5 mm×25 mm) was applied along a second edge of the substrate, perpendicular to the SiO deposit. Copper phthalocyanine was thermally deposited on the ITO surface through a mask to form a hole-injection layer (10 nm). A solution consisting of 1.5% of poly[3-[N-carbazolyl)-propylmethylsiloxane] in toluene was spin-coated over the hole-injection layer to form a hole-transport layer having a thickness of 40 nm. The composite was heated in an oven under nitrogen at 80° C. for 30 min and then allowed to cool to room temperature. A solution consisting of 2% of poly[{9,9-dihexyl-2,7-bis(1-cyanovinylene)fluorenylene}-alt-co-{2,5-bis(N,N-diphenylamino)-1,4-phenylene}] (American Dye Sources, Inc., Quebec, Canada) in electronic grade methyl isobutyl ketone was spin-coated over the hole-transport layer to form an electron-transport layer having a thickness of 50 nm. The composite was again heated in an oven under nitrogen at 80° C. for 30 min and then allowed to cool to room temperature. The strip of tape was removed from the substrate to expose the anode (ITO), and lithium fluoride was thermally deposited on the electron-transport layer through a mask to form an electron-injection layer (1 nm). Four cathodes were formed by depositing calcium (50 nm) on the electron-injection layer and SiO deposit through a mask having four rectangular apertures (3 mm×16 mm) and then depositing aluminum (100 nm) on the calcium through the mask. The electrical and optical properties of a representative OLED are shown in Table 2.

[image]

### Example 9

Four OLEDs were fabricated as described in Example 8, except the hole-transport layer and electron transport layer were formed as follows: A silicone composition consisting of 1.5% of the carbazolyl-functional linear polysiloxane of Example 3 and 0.004% of titanium diisopropoxide bis(ethylacetoacetate), which is sold under the name TYZOR DC by DuPont (Wilmington, Del.), in electronic grade toluene was spin-coated over the hole-injection layer to form a polysiloxane film. The film was allowed to stand at ambient temperature and humidity for 2 h and then heated in an oven at 140° C. for 30 min to form a hole-transport layer having a thickness of 40 nm. Tris(8-hydroxyquinolato)aluminum (III), Alq₃, was thermally deposited on the hole-transport layer to form an electron-transport layer (30 nm). The electrical and optical properties of a representative OLED are shown in Table 2.

### Example 10

Four OLEDs (see figure below) were fabricated as described in Example 8, except the hole-injection layer was omitted and the hole-transport layer, electron transport layer, and cathodes were formed as follows: A solution consisting of 1.3% of poly(3,4-ethylenedioxythiophene) poly(styrenesulfonate), abbreviated PEOT:PSS below, which is sold under the name Baytron® P by H.C. Starck Inc., in water was spin-coated over the ITO surface to form a hole-transport layer having a thickness of 50 mm. The composite was heated in an oven under nitrogen at 70° C. for 60 min and then allowed to cool to room temperature. A solution consisting of 1.5% of poly[3-[N-carbazolyl)propylethylsiloxane] in toluene was spin-coated over the hole-transport layer to form an electron-transport layer having a thickness of 40 nm. The composite was heated in an oven under nitrogen at 80° C. for 30 min. The four cathodes were formed by depositing aluminum (100 nm) on the electron-injection layer and SiO deposit through a mask having four rectangular apertures (3 mm×16 mm). The electrical and optical properties of a representative OLED are shown in Table 2.

[image]

### Example 11

Four OLEDs were fabricated as described in Example 8, except the hole-injection layer was omitted and the hole-transport layer, electron-transport layer, and cathodes were formed as follows: A solution consisting of 1.5% of poly[3-[N-carbazolyl)propylethylsiloxane] and 0.1% of rubrene (5,6,11,12-tetraphenylnaphthacene) in toluene was spin-coated over the ITO surface to form a hole-transport layer having a thickness of 40 nm. The composite was heated in an oven under nitrogen at 80° C. for 30 min. Tris(8-hydroxyquinolato)aluminum (III), Alq₃, was thermally deposited on the hole-transport layer to form an electron-transport layer (30 nm). The four cathodes were formed by depositing aluminum (100 nm) on the electron-injection layer and SiO deposit through a mask having four rectangular apertures (3 mm×16 mm). The electrical and optical properties of a representative OLED are shown in Table 2.

### Example 12

Four OLEDs were fabricated as described in Example 8, except the hole-transport layer was formed as follows: A solution consisting of 1.25% of poly[3-[N-carbazolyl)propylethylsiloxane], 0.055% of 4-(dicyanomethylene)-2-methyl-6-(p-dimethylaminostyryl)4H-pyran (Fisher Scientific/Acros Organics), and 0.075% of 1,4-Bis(4-methyl-5-phenyloxazol-2-yl)benzene (Aldrich, Milwaukee, Wis.) in toluene was spin-coated over the hole-injection layer to form a hole-transport layer having a thickness of 40 nm. The electrical and optical properties of a representative OLED are shown in Table 2.

TABLE 2

| | Turn-On | | Relative | Electroluminescent | |
|---|---|---|---|---|---|
| | Voltage | Brightness | Efficiency | Properties | |
| Example | (V) | (cdm⁻²) | (cdA⁻¹) | λₘₐₓ (nm) | PW₅₀ (nm) |
| 8 | 9.8 | 103 | — | 639 | 82 |
| 9 | 8.5 | 72 | 1.07 | 505 | 85 |
| 10 | — | — | — | 417 | 52 |
| 11 | 6.6 | 527 | 0.73 | 555 | 64 |
| 12 | 7.6 | 568 | 1.79 | 500, 570 | 148 |

— denotes property not measured.

That which is claimed is:

1. A carbazolyl-functional linear polysiloxane comprising from 30 to 99 mol % of units having the formula I, from 1 to 70 mol % of units having the formula II, and units having the formula III: 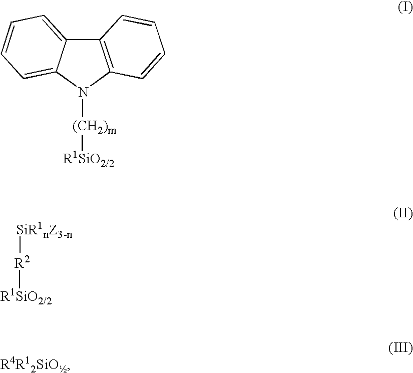
wherein R¹ is C₁ to C₁₀ hydrocarbyl free of aliphatic unsaturation; R² is —CH₂—CHR³— or —CH₂—CHR³—Y—, wherein Y is a divalent organic group and R³ is R¹ or —H; R⁴ is R¹, —(CH₂)ₘ-Cz, —CH₂—CHR³—SiR¹ₙZ₃₋ₙ, or —CH₂—CHR³—Y—SiR¹ₙZ₃₋ₙ, wherein Cz is N-carbazolyl; Z is a hydrolysable group; m is an integer from 2 to 10; and n is 0, 1, or 2.

2. The carbazolyl-functional linear polysiloxane according to claim 1, wherein the polysiloxane comprises from 75 to 99 mol % of units having the formula (I) and from 5 to 50 mol % of units having the formula (II).

3. The carbazolyl-functional linear polysiloxane according to claim 1, wherein the polysiloxane contains up to 15 mol % of siloxane units having formulae selected from R¹HSiO_{2/2}, HR¹₂SiO_{1/2}, R¹₂SiO_{2/2}, and combinations thereof, wherein R¹ is C₁ to C₁₀ hydrocarbyl free of aliphatic unsaturation.

4. A carbazolyl-functional linear polysiloxane comprising at least 30 mol % of units having the formula I and units having the formula IV: 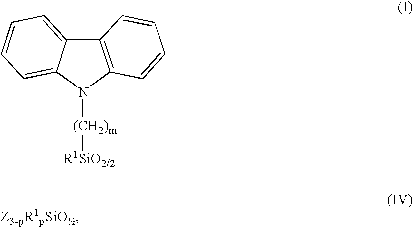
wherein R¹ is C₁ to C₁₀ hydrocarbyl free of aliphatic unsaturation; Z is a hydrolysable group; m is an integer from 2 to 10; and p is 0, 1, or 2.

5. The carbazolyl-functional linear polysiloxane according to claim 4, wherein the polysiloxane contains at least 70 mol % of units having formula I.

6. The carbazolyl-functional linear polysiloxane according to claim 4, wherein the polysilxoane contains up to 15 mol % of siloxane units having formulae selected from R¹HSiO_{2/2}, HR¹₂SiO_{1/2}, R¹₂SiO_{2/2}, and combinations thereof, wherein R¹ is C₁ to C₁₀ hydrocarbyl free of aliphatic unsaturation.

7. A silicone composition comprising:
(A) a polysiloxane selected from (i) at least one carbazolyl-functional linear polysiloxane comprising from 30 to 99 mol % of units having the formula I, from 1 to 70 mol % of units having the formula II, and units having the formula III: 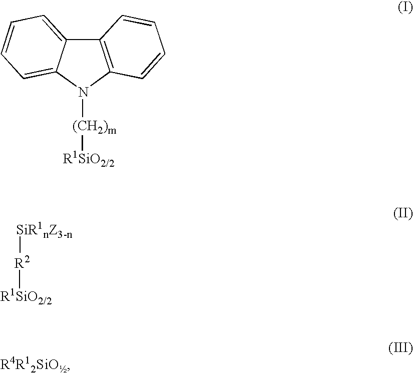
wherein R¹ is C₁ to C₁₀ hydrocarbyl free of aliphatic unsaturation, R² is —CH₂—CHR³— or —CH₂—CHR³—Y—, wherein Y is a divalent organic group and R³ is R¹ or —H, R⁴ is R¹, —(CH₂)ₘ-Cz, —CH₂—CHR³—SiR¹ₙZ₃₋ₙ, or —CH₂—CHR³—Y—SiR¹ₙZ₃₋ₙ, wherein Cz is N-carbazolyl, Z is a hydrolysable group, m is an integer from 2 to 10, and n is 0, 1, or 2, and (ii) at least one carbazolyl-functional linear polysiloxane comprising at least 30 mol % of units having the formula I and units having the formula IV: 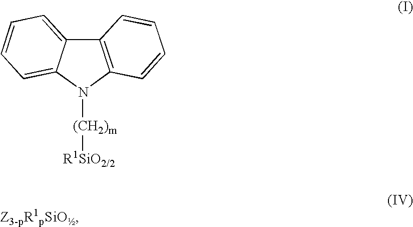
wherein R¹ is C₁ to C₁₀ hydrocarbyl free of aliphatic unsaturation, Z is a hydrolysable group, m is an integer from 2 to 10, and p is 0, 1, or 2, and (iii) a mixture comprising (i) and (ii); and
(B) an organic solvent.

8. The silicone composition according to claim 7, wherein the polysilxoane (A) is (A)(ii) wherein p has a value of 2, and further comprising a cross-linking agent having the formula R⁵_{q}SiZ_{4-q}, wherein R⁵ is C₁ to C₈ hydrocarbyl or halogen-substituted hydrocarbyl, Z is a hydrolysable group, and q is 0 or 1.

9. An organic light-emitting diode comprising:
a substrate having a first opposing surface and a second opposing surface;
a first electrode layer overlying the first opposing surface;
a light-emitting element overlying the first electrode layer, the light emitting element comprising
a hole-transport layer and
an electron-transport layer, wherein the hole-transport layer and the electron-transport layer lie directly on one another, and one of the hole-transport layer and the electron-transport layer comprises a carbazolyl-functional polysiloxane selected from
a cured carbazolyl-functional polysiloxane prepared by curing a silicone composition comprising (A) a polysiloxane selected from (i) at least one carbazolyl-functional linear polysiloxane comprising from 30 to 99 mol % of units having the formula I, from 1 to 70 mol % of units having the formula II, and units having the formula III: 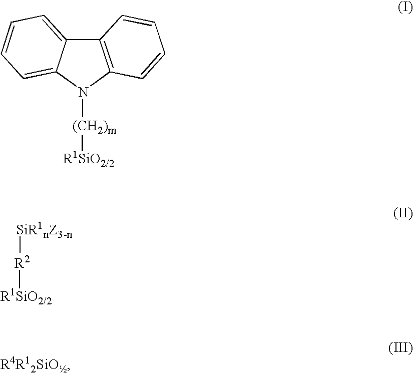
wherein R¹ is C₁ to C₁₀ hydrocarbyl free of aliphatic unsaturation, R² is —CH₂—CHR³— or —CH₂—CHR³—Y—, wherein Y is a divalent organic group and R³ is R¹ or —H, R⁴ is R¹, —(CH₂)ₘ-Cz, —CH₂—CHR³—SiR¹ₙZ₃₋ₙ, or CH₂—CHR³—Y—SiR¹ₙZ₃₋ₙ, wherein Cz is N-carbazolyl, Z is a hydrolysable group, m is an integer from 2 to 10, nd n is 0, 1, or 2, (ii) at least one carbazolyl-functional linear polysiloxane comprising at least 30 mol % of units having the formula I and units having the formula IV: 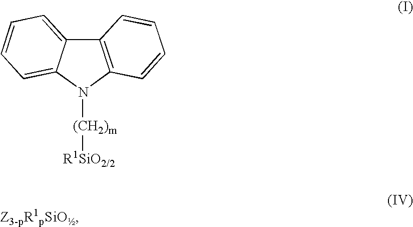
wherein R¹ is C₁ to C₁₀ hydrocarbyl free of aliphatic unsaturation, Z is a hydrolysable group, m is an integer from 2 to 10, and p is 0, 1, or 2, and (iii) a mixture comprising (i) and (ii), and (B) an organic solvent, and
at least one carbazolyl-functional linear polysiloxane comprising at least 50 mol % of units having the formula I, and units having the formula V: 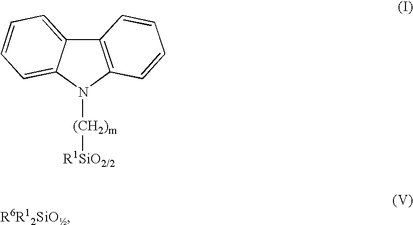
wherein R¹ is C₁ to C₁₀ hydrocarbyl free of aliphatic unsaturation, m is from 2 to 10, and R⁶ is R¹ or —(CH₂)ₘ-Cz, wherein Cz is N-carbazolyl; and
a second electrode layer overlying the light-emitting element.

10. The organic light-emitting diode according to claim 9, wherein the hole-transport layer is a carbazolyl-functional polysiloxane.

11. The organic light-emitting diode according to claim 9, wherein the electron-transport layer is a carbazolyl-functional polysiloxane.
